(19) United States
(12) Patent Application Publication
(10) Pub. No.: US 2006/0254530 A1
(43) Pub. Date: Nov. 16, 2006

(54) Cat scratching toy

(76) Inventor: Barry Askinasi, Mt. Sinai, NY (US)

Correspondence Address: DARBY & DARBY P.C., P. O. BOX 5257, NEW YORK, NY, 10150-5257, US

(21) Appl. No.: 11/129,067

(22) Filed: May 13, 2005

(51) Int. Cl. A01K 29/00

(52) U.S. Cl. 119/706

(57) ABSTRACT

A self-supporting, stuffed toy which is constructed to both promote and withstand scratching and climbing by cats, and may be stuffed with catnip to entice a cat to scratch its surface. The toy may represent an animal and be configured for resilience to scratching by cats, while at the same time keeping the appeal of a soft touchable toy.

### FIELD OF THE INVENTION

The present invention relates generally to cat scratching and exercising apparatuses. In particular, the present invention relates to a self-supported toy animal constructed to withstand and promote cat climbing and scratching, which may be stuffed with catnip to entice a cat to scratch the toy rather than furniture.

### BACKGROUND OF THE INVENTION

It is well known that cats have an innate need to sharpen their claws on a daily basis, and that they often choose household furniture on which to do so. This results in frayed, tattered, and unsightly wall surfaces and furniture.

Many cat owners purchase cat scratching posts, which are generally comprised of free standing, wooden posts covered with carpeting. However, these devices are less than ideal because they can be tipped over by the force of the cat's clawing motions, which often startles the cat making it less likely to use it to satisfy its clawing needs. Also, these scratching posts are relatively large and take up considerable space in the main living room of the home. With continued use, they look tattered and unsightly and the owner may then either wastefully throw the scratching post away, or keep it and allow it to detract from the appearance of the room in which it is placed.

Stuffed toys are designed for a variety of uses. For example, children and pets play with stuffed animals, dolls, balls, and other toys having innumerable shapes and sizes. Numerous stuffed toy animals and figures have been provided which are made of a soft plush material. Stuffed animals made of plush material, however, are not sufficiently protected against cat scratching.

No conventional solution provides a self-supporting, stuffed toy animal which is constructed to both promote and withstand scratching and climbing by cats, and may be stuffed with catnip to entice a cat to scratch its surface. Accordingly, there is a need for a stuffed toy animal which is realistic looking and resilient to scratching by cats, while at the same time keeping the appeal of a soft touchable plush toy. It is also desired that the stuffed toy animal be safe, easy to assemble and inexpensive to produce.

### SUMMARY OF THE INVENTION

The present invention generally relates to stuffed toy animals and, more particularly, to a stuffed toy animal equipped with a scratch resilient surface. The invention can also be utilized in making stuffed toy humans, animals, primates, cartoon figures, babies, monsters and other creatures and characters having scratch resilient features, preferably to both promote play by cats and provide an aesthetically pleasing and/or humorous stuffed figure.

The stuffed toy animal of the present invention includes a body formed of a fabric material and filled with a stuffing material; and a resilient member extending for a portion of the body adapted for resilience to scratching. The stuffed toy is configured to stimulate and withstand scratching by an animal during play by the animal.

In accordance with one aspect of the invention, a measure of catnip may be added to the stuffing material to provide additional enticement for a cat to scratch at the resilient member. In accordance with another aspect of the invention, the toy is in the shape of a representational dog and the body is made from material selected from the group consisting of sisal, hemp, loofah, nylon, sponge (natural and synthetic), and brush.

These and further aspects, features and advantages of the present invention will become more apparent from the following detailed description when taken in connection with the accompanying drawings which show, for purposes of illustration only, a preferred embodiment of the present invention.

### BRIEF DESCRIPTION OF THE DRAWINGS

The present invention is illustrated by way of example and not by way of limitation in the figures of the accompanying drawings in which like references indicate similar elements. It should be noted that the references to “an” or “one” embodiment of this disclosure are not necessarily to the same embodiment, and such references mean at least one.

FIG. 1 is perspective view of a particular stuffed toy animal having a scratch resilient surface secured to a soft body in accordance with the principals of the present invention;

FIG. 2 is a top view of the stuffed toy animal of FIG. 1; and

FIG. 3 is a bottom view of the stuffed toy animal of FIG. 1.

### DETAILED DESCRIPTION OF CERTAIN EMBODIMENTS

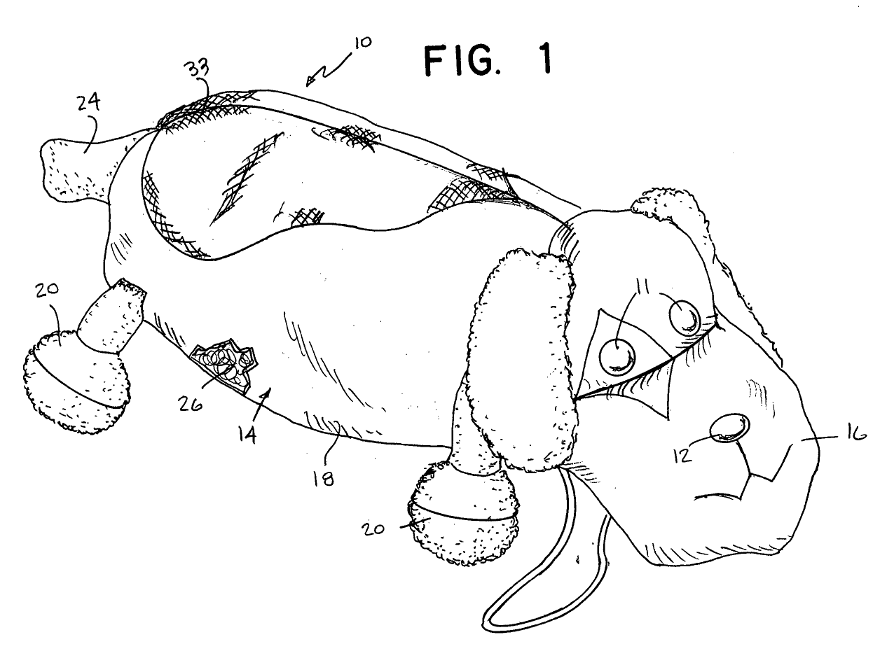

Referring to FIG. 1 a perspective view of a particular stuffed toy animal 10 having a scratch resilient member 33 secured to a soft body 14 in accordance with the principals of the present invention is designated.

While the illustrated stuffed toy resembles a dog, it is noted that it can alternatively form another animal, a primate, a human, a cartoon figure, a fantasy figure, a highly recognizable licensed figure, or any other desired figure. The illustrated three-dimensional stuffed dog includes artificial eyes 11 and nose 12, a soft body 14, and a soft head 16.

The body 14 and the head 16 are formed from planar blanks known in the art of appropriate configurations and dimensions to form the desired stuffed toy, such as the illustrated dog. The illustrated body 14 includes a belly 18, two pair of legs 20, and a tail 24. The planar blanks are preferably a fabric, knit or woven material preferably having a fur on one side such as, for example, acrylic pile, modified acrylic pile, cotton pile, cotton lycra pile, polyester pile, or nylon pile. The blanks may or may not comprise a plush material. The blanks are secured together to form the three-dimensional or contoured members each forming an internal cavity. The blanks are preferably sewn or stitched together and are preferably blind stitched with heavy cotton thread.

The cavities are preferably filled with a combination of stuffing material 26 (e.g. fiberfill) and catnip. Fiberfill is used herein to indicate any material, natural or synthetic, providing an effective degree of loft or stuffing. A preferred fiberfill is synthetic wadding or batting such as a polyester fiberfill. Additionally, in accordance with an alternative arrangement, heavier materials and compositions can be added to stuffing material 26 to add weight to toy 10. The added weight provided by such materials will prevent the toy from moving under ordinary scratching from cats.

The artificial eyes and nose, 11 and 12, respectively, are preferably rigid and stiff and are preferably polyvinylchloride, but other hard plastics, such as thermoplastics or thermosets, or other hard materials, such as metals, known in the art which give the desired details may be used. The artificial eyes and nose, 11 and 12, respectively, are firmly secured to the front of the head 16 and include a pair of locking washers (not shown). Alternative locking arrangements, as known in the art, may also be used to secure the eyes and nose. Scratch resistant member 33 can be sewn or stitched to body 14 as discussed in more detail below or it can be secured to the body 14 by adhesives, heat fusion or the like to prevent its accidental separation.

Resilient member 33 can be composed of various materials, i.e., carpeting, sisal rope, or any other material that is appropriate for a cat to scratch or climb. According to a preferred embodiment, resilient member 33 is a woven sisal fabric having a coarse array of loops that provide an enhanced reliance to scratching.

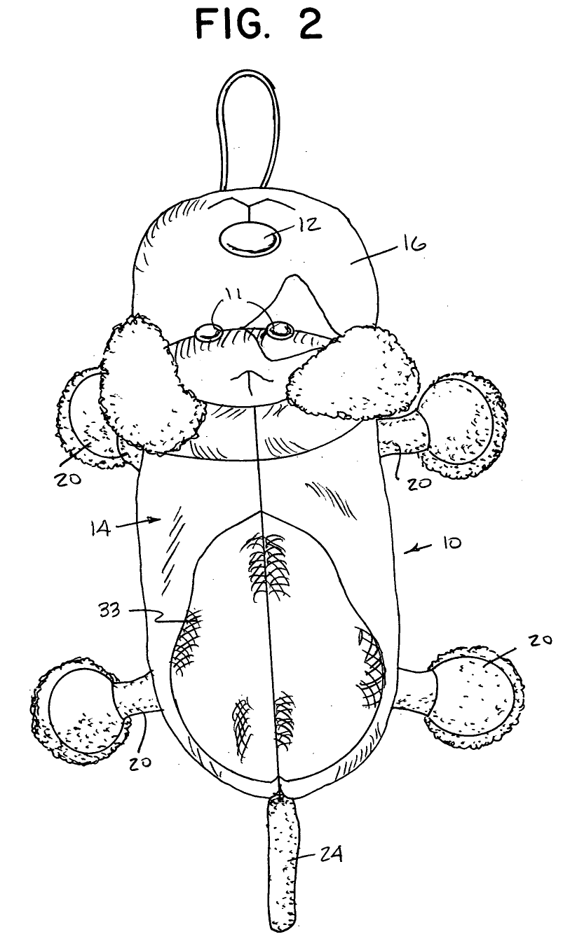

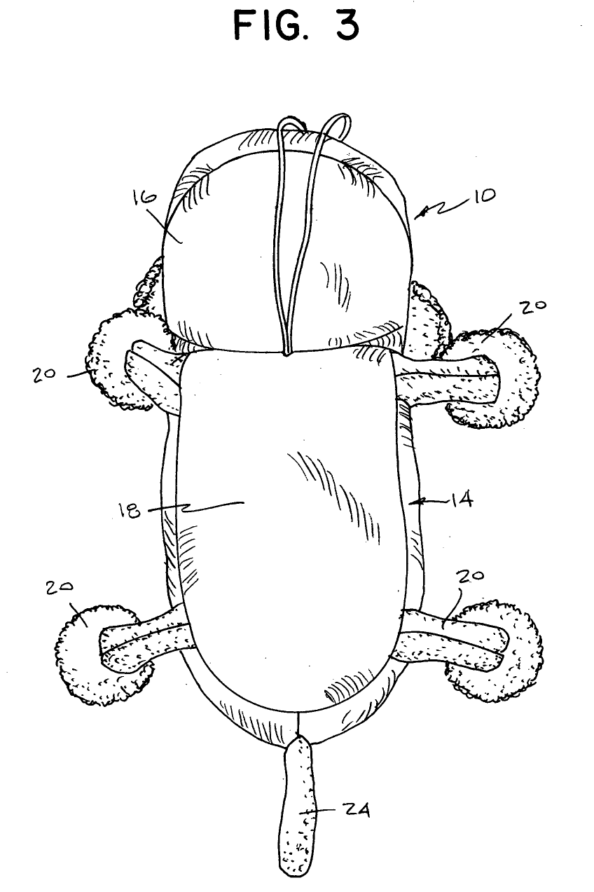

Body 14 of toy 10 is configured to provide the overall shape of the toy and to create an inner pocket or cavity to hold the stuffing material 26. Referring to FIGS. 1-3, toy 10 generally includes a first surface (body 14) and a more abrasive second surface (resilient member 33). In preferred embodiments, body 14 is joined to the resilient member 33 along their common edges. Suitable methods include knitting, sewing, or stitching. Body 14 is made from any suitably flexible material such as terry cloth, Turkish bath towel, nylon, cotton or fur. Resilient member 33 is more abrasive than any other surface on toy 10 and is formed to provide a scratching or climbing action for the cat. Resilient member 33 is made of any suitably flexible material having an effective degree of porosity, coarseness, and abrasiveness. Preferably, the materials of member 33 are woven such that the fabric has a coarse grouping of small loops that provide an enhanced scratching surface. Suitable materials for resilient member 33 include woven sisal, hemp, loofah, nylon, sponge (natural and synthetic), brush, and the like.

The exact dimensions and shape of the toy 10 of the present invention may vary depending upon the age and size of the cat. In embodiments targeted at kittens, the overall size of the toy may be configured smaller than if it were for larger, adult cats. For example, one arrangement features a toy 10 configured to provide an overall dog shape where the back of the dog-shaped toy is made of an abrasive scratch resilient surface and the remaining portions are made of a cloth material.

From the above description it can be seen that stuffed toy 10 is realistic looking by having a detailed face, soft body 14 and head 16, while at the same time providing a resilient member 33 for cats to sink their claws into. It can also be seen that the toy 10 is safe, easy to assemble, fairly inexpensive to produce, and very durable and resilient, especially to scratching.

As discussed briefly above, embodiments of the cat and kitten toy technology described herein may be applied to resemble other animals, such as, such as dogs, cows, sheep, geese, fish, whales, elephants, starfish, lobsters, crabs, dinosaurs, dolphins, sharks, buffaloes, pigs, chickens, turtles, rabbits, penguins, ducks, swans, mice, manatees, monkeys, apes, platypuses, birds, seals, otters, mongooses, opossum, raccoons, chipmunks, squirrels, lizards, snakes, hippos, frogs, alligators, crocodiles, lions, tigers, bears, and the like. Furthermore, while specific embodiments of the scratchable toy of the present invention have been shown and described, it will be appreciated by those skilled in the art that changes and modifications may be made thereto without departing from the invention in its broader aspects.

While the invention has been described with reference to several embodiments thereof, the invention is more broadly defined and limited only by the recitations in the claims appended hereto and their legal equivalents.

1. A stuffed toy configured to withstand scratching, comprising:
a body formed of a fabric material and filled with a stuffing material;
a resilient member comprising sisal, hemp, loofah, natural sponge, synthetic sponge, or brush extending for a portion of said body, wherein the resilient member is externally exposed and adapted for resilience to scratching; and
a measure of catnip within the body.

2. The arrangement according to claim 1, wherein the measure of catnip within the body is contained within the stuffing material.

3. (canceled)

4. The arrangement according to claim 1, wherein said toy is in the shape of a representational dog or mouse.

5. A stuffed toy configured to stimulate and withstand scratching by an animal during play by said animal, said stuffed toy comprising:
a body;
a resilient member comprising sisal, hemp, loofah, nylon, natural sponge, synthetic sponge, or brush connected to said body, wherein the resilient member is externally exposed and adapted for resilience to scratching; and
a play-stimulation item wholly contained within said body and configured to issue an emission detectable through said body and said resilient member by at least one sense of said animal, wherein the play-stimulation item comprises a combination of catnip and stuffing material.

6. A stuffed toy as claimed in claim 5 wherein said body comprises a fabric material.

7. A stuffed toy as claimed in claim 6 wherein said fabric material is an artificial fur.

8. The stuffed toy as in claim 1 further comprising artificial eyes, an artificial nose, and a head.

9. (canceled)

10. The stuffed toy as in claim 9 wherein the body and head have a fur on one side comprising acrylic pile, modified acrylic pile, cotton pile, cotton lycra pile, polyester pile, or nylon pile.

11-12. (canceled)

13. The stuffed toy as in claim 1 wherein the stuffing material comprises a synthetic wadding or batting.

14. (canceled)

15. The stuffed toy as in claim 1 wherein the resilient member is a woven sisal fabric having a coarse array of small loops.

16. The stuffed toy as in claim 1 wherein the resilient member is more abrasive than any other surface on toy.

17. The stuffed toy as in claim 1 wherein the body is flexible and comprises terry cloth, turkish bath towel, nylon, cotton or fur.

18. The stuffed toy as in claim 1 wherein the toy is in the shape of an animal, primate, human, cartoon figure, fantasy figure, or highly recognizable licensed figure.

19. The stuffed toy as in claim 5, wherein the body is represented in a shape of an animal.

20. The stuffed toy as in claim 5, wherein said toy is in the shape of an animal, primate, human, cartoon figure, fantasy figure, or highly recognizable licensed figure.

21. The stuffed toy as in claim 1, wherein the toy is configured to withstand climbing by an animal.

22. A stuffed toy in the shape of a representational dog or mouse configured to withstand scratching by an animal during play by the animal, comprising:
a body formed of a fabric material and filled with cotton; and
a resilient member comprising sisal, hemp, loofah, natural sponge, synthetic sponge, or brush extending for a portion of said body, wherein the resilient member is externally exposed and adapted for resilience to scratching.
